(19) United States
(12) Patent Application Publication
(10) Pub. No.: US 2022/0305330 A1
(43) Pub. Date: Sep. 29, 2022

(54) INTELLIGENT EXERCISE BIKE

(71) Applicant: WENZHOU AIRUIDE TECHNOLOGY CO., LTD., Wenzhou (CN)

(72) Inventor: Fengyu Cai, Wenzhou (CN)

(21) Appl. No.: 17/376,143

(22) Filed: Jul. 14, 2021

(30) Foreign Application Priority Data
Mar. 23, 2021 (CN) 202110307160.0

(51) Int. Cl. A63B 22/06; A63B 24/00; A63B 71/04

(52) U.S. Cl. CPC A63B 22/0605; A63B 24/0062; A63B 24/0087; A63B 71/04; A63B 2220/54; A63B 2220/833; A63B 2220/89; A63B 2071/0675

(57) ABSTRACT

An intelligent exercise bike includes a frame, and a front wheel and a rear motor wheel, wherein the frame is provided with a pedal motor electrically connected with the pedal, and the output shaft of the pedal motor is drivingly connected with the pedal; the pedal motor has a torque sensor and a Hall sensor that are electrically connected thereto for detecting the speed and force of the pedal; a bike controller is provided in the frame, and the torque sensor and the Hall sensor convert the detected pedal speed and force into transmission signals, and output them to the bike controller; the bike controller is connected to a power supply circuit of the rear motor wheel, and the bike controller outputs a control signal to adjust the output power value of the rear motor wheel after receiving the transmission signals.

### CROSS REFERENCE TO RELATED APPLICATIONS

This application claims priority to Chinese Patent Application No. 202110307160.0, filed on Mar. 23, 2021. The entirety of the above-mentioned patent application is hereby incorporated by reference herein and made a part of this specification.

### BACKGROUND

### Technical Field

The present application relates to the field of bikes, in particularly to an intelligent exercise bike.

### Description of Related Art

At present, a bike uses a chain as a transmission source, and a pedal is used to drive the chain to drive the wheels to rotate, and finally drives the bike forward. It is a green and environmentally friendly transportation tool.

In the related art, the Chinese patent with the authorized announcement number CN205998081U discloses a bike, in which a closed chain drive formed by a chain includes a second flywheel, a third flywheel, a pulley, a guide wheel and a transmission rope. During riding, the transmission rope is reciprocated by pedaling during riding, which drives the second flywheel or the third flywheel to drive a first rotating shaft, and then the motion is transferred to the first flywheel through a sprocket, so as to drive a rear wheel to rotate and realize the forward movement of the bike.

In view of the above-mentioned related technologies, the inventor believes that due to the poor transmission stability of the chain transmission, it is easy to feel frustrated when riding, which in turn leads to a decrease in the stability of the bike during riding, so that there is a certain of hidden safety dangers during riding.

### SUMMARY

In order to improve the problem of poor stability during riding, the present application provides an intelligent exercise bike.

The intelligent exercise bike provided by the present application adopts the following technical solutions.

An intelligent exercise bike includes a frame, and a front wheel and a rear motor wheel that are rotatably provided on the frame, wherein a pedal and a battery are provided on the frame, and the battery is electrically connected to the rear motor wheel and used to supply power to the rear motor wheel; the frame is also provided with a pedal motor electrically connected with the pedal, and the output shaft of the pedal motor is drivingly connected with the pedal; the pedal motor has a torque sensor and a Hall sensor that are electrically connected thereto for detecting the speed and force of the pedal; a bike controller is provided in the frame, and the torque sensor and the Hall sensor convert the detected pedal speed and force into transmission signals, and output them to the bike controller; the bike controller is connected to a power supply circuit of the rear motor wheel, and the bike controller outputs a control signal to adjust the output power value of the rear motor wheel after receiving the transmission signals.

By adopting the above technical solution, when the user is riding, the pedal will drive the output shaft of the pedal motor to rotate, and the torque sensor and the Hall sensor provided on the pedal motor can collect the speed and force of the user's pedaling. The torque sensor and the Hall sensor can convert the detected physical quantity into transmission signals and send them to the bike controller. The bike controller will process the transmission signals after receiving the transmission signals, and finally outputs the corresponding control signal to control the power value received by the rear motor wheel from the battery, and thus the control and adjustment of the speed and torque of the rear motor wheel are achieved. The chain drive, shaft drive, timing belt drive and other mechanical transmissions in the traditional bike are omitted, which can greatly improve the stability during riding and reduce the incidence of mechanical failure of the bike. Moreover, the pedal force is not fed back by the wheels, so it can better adapt to various road conditions and slopes; and the torque force of the pedal motor can also be adjusted by the bike controller, thereby meeting the riding needs of different users.

### BRIEF DESCRIPTION OF THE DRAWINGS

FIG. 1 is a schematic diagram of the overall structure of the present application embodiment.

FIG. 2 is a schematic diagram of the partial structure of FIG. 1 after replacing a storage box with a child seat.

FIG. 3 is a schematic diagram of the overall structure of a pedal in FIG. 2.

FIG. 4 is a schematic diagram of the overall structure of a support assembly highlighted in FIG. 1.

### DESCRIPTION OF REFERENCE SIGNS

1—frame; 11—main frame body; 12—handle; 13—cushion frame; 14—taillight; 15—spring shock absorber; 16—foot rest; 161—mount groove; 17—storage box; 171—storage cavity; 172—lifting grip; 18—child seat; 181—armrest; 2—front wheel; 3—rear motor wheel; 4—pedal; 5—pedal motor; 6 battery; 7—speed adjustment knob; 8—support assembly; 81—base; 82—connector; 821—limit groove; 83—accommodating cavity; 9—folding mechanism.

### DESCRIPTION OF THE EMBODIMENTS

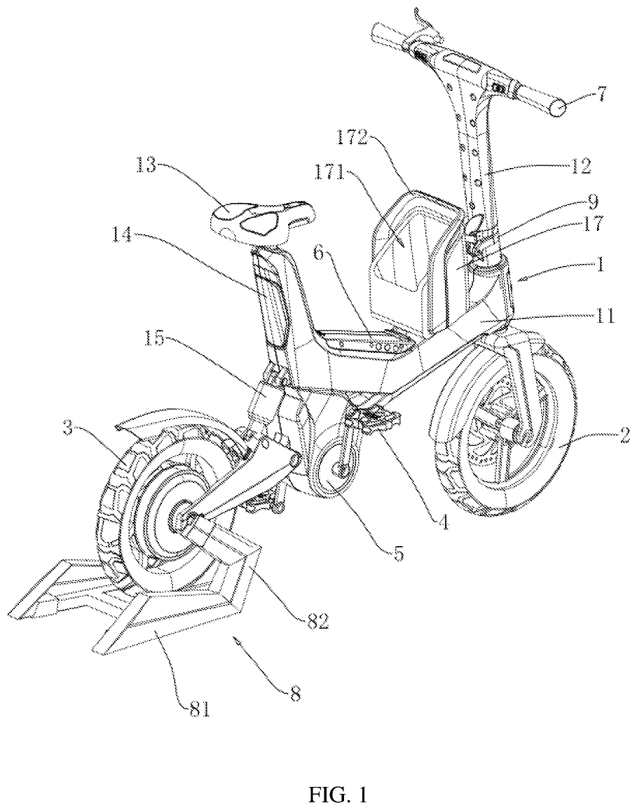

The present application will be described in further detail below in conjunction with FIGS. 1-4.

The present application embodiment discloses an intelligent exercise bike. Referring to FIG. 1, the intelligent exercise bike includes the frame 1, the front end of the frame 1 is rotatably mounted with a front wheel 2, and the rear end of the frame 1 is rotatably mounted a rear motor wheel 3. The frame 1 is also mounted with a pedal 4, the pedal motor 5 and the battery 6 between the front wheel 2 and the rear motor wheel 3. The battery 6 and the rear motor wheel 3 are electrically connected with each other, and the battery 6 is used to supply power to the rear motor wheel 3. Through the battery 6, the power is output to the rear motor wheel 3, and then realize the rotation of the rear motor wheel 3.

As shown in FIG. 1, the frame 1 includes a main frame body 11, the pedal 4 is rotatably provided on the main frame body 11, the output shaft of the pedal motor 5 is linked with the rotation shaft of the pedal 4, and the pedal 4 and the motor pedal 5 are electrically connected with each other. The pedal motor 5 has a torque sensor and a Hall sensor that are electrically connected thereto. When a user drives the output shaft of the pedal motor 5 to rotate by stepping on the pedal 4, the torque sensor and the Hall sensor can collect the speed of the motor pedal 5 and the force exerted by the pedal 4 on the output shaft of the pedal motor 5.

As shown in FIG. 1, the bike controller is also mounted in the main frame body 11. The bike controller is electrically connected to the battery 6 and the power supply circuit of the rear motor wheel 3. When the user drives the output shaft of the pedal motor 5 to rotate by stepping on the pedal 4, the torque sensor and the Hall sensor convert the detected speed of the pedal motor 5 and the force of the pedal 4 into transmission signals, and transmit them to the bike controller. The bike controller performs data analysis and processing according to the received transmission signals, and then outputs a corresponding control signal to control the power value received by the rear motor wheel 3. In this embodiment, the bike controller can output a control signal of a corresponding size according to the pulse width of the received transmission signals to control the power value input by the battery 6 to the rear motor wheel 3. At this time, the bike can be used as a bicycle, and the chain drive, shaft drive, timing belt drive and other mechanical transmissions in the traditional bike are omitted, which can greatly improve the stability during riding and reduce the incidence of mechanical failure of the bike. Moreover, the pedal force is not fed back by the wheels, so it can better adapt to various road conditions and slopes.

As shown in FIG. 1, the frame 1 also includes a handle 12 mounted at the front end of the main frame body 11. The handle 12 is located directly above the front wheel 2. A folding mechanism 9 is provided between the lower end of the handle 12 and the main frame body 11. The folding mechanism 9 includes a folding joint provided at the lower end of the handle 12, a standpipe folding joint provided on the main frame body 11, and a fastener that locks the folding joints and the standpipe folding joints. After unscrewing the fastener, the connection between the handle 12 and the main frame body 11 can be folded, which facilitates the storage of the body. A speed adjustment knob 7 is rotatably mounted on the handle 12, and is electrically connected to the bike controller. By rotating the speed adjustment knob 7, the speed adjustment knob 7 outputs a corresponding speed adjustment signal according to the rotation angle. The speed adjustment signal relates specifically to outputting a voltage value of a corresponding magnitude. When the bike controller receives the speed adjustment signal output by the speed adjustment knob 7, the bike controller outputs the corresponding control signal according to the size of the speed adjustment signal to adjust the power output from the battery 6 to the rear motor wheel 3, so as to realize the adjustment of the speed and torque of the rear motor wheel 3. The bike can be used as an electric vehicle under the action of the speed adjustment knob 7. A button switch or a touch switch may be added to the handle 12, wherein a set of switches is used to control the connection and interruption of the signal between the pedal motor 5 and the battery 6, and the other set of switches is used to control the connection and interruption of the signal between the speed adjustment knob 7 and the battery 6. Thus, the switching of the bike between the bicycle mode and the electric vehicle mode can be achieved. The user rotates the speed adjustment knob 7, the speed adjustment knob 7 outputs the speed adjustment signal to the bike controller, and finally through the bike controller, the power output from the battery to the rear motor wheel 3 can be adjusted. The provision of the speed adjustment knob can achieve the switching of the bike from the bike mode to the electric vehicle mode, thereby meeting the different riding needs of users. When the bike is switched to the electric vehicle mode, it can make driving more labor-saving and convenient.

As shown in FIG. 1, the frame 1 also includes a cushion frame 13 mounted at the rear end of the main frame body 11. A taillight 14 is provided at the end of the cushion frame 13 away from the handle 12 in the front, and is electrically connected to the battery 6. The battery 6 is used to power the taillight 14, and the taillight 14 can act as a reminder to the bikes behind, thereby improving the safety of the user when riding at night. A spring shock absorber 15 under the taillight 14 is mounted between the cushion frame 13 and the main frame body 11. One end of the spring shock absorber 15 is connected to the cushion frame 13, and the other end of the spring shock absorber 15 is connected to the main frame body 11. When the bike is driving on a bumpy road, the spring shock absorber 15 can have the effect of damping and buffering, thereby improving the comfort of the cushion frame 13 during riding.

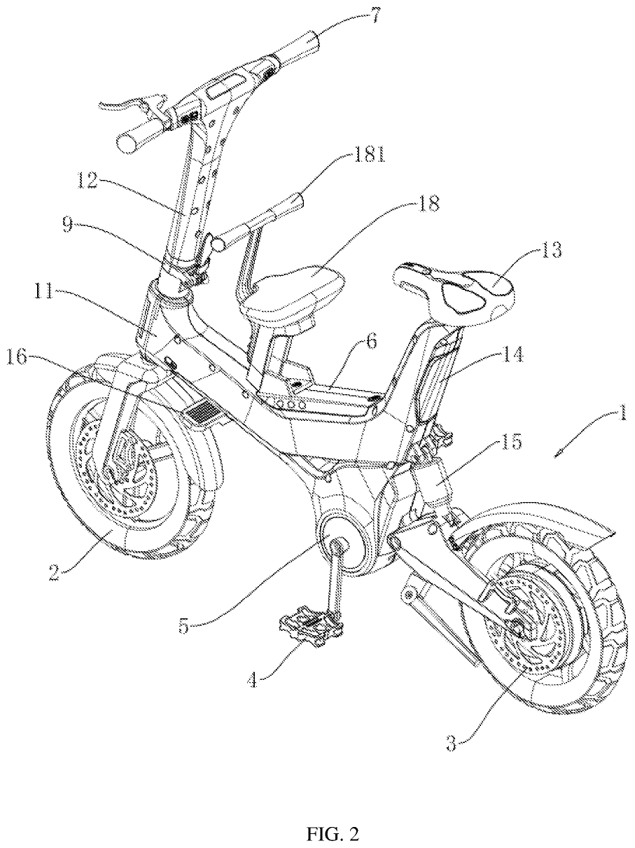

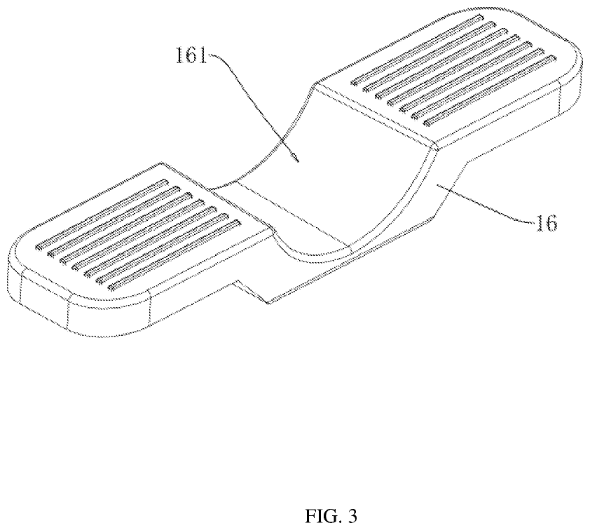

As shown in FIGS. 2 and 3, in order to facilitate the user's footsteps, a foot rest 16 may also be mounted on the main frame body 11 between the handle 12 and the cushion frame 13, and the foot rest 16 is provided at the bottom of the main frame body 11. An arc-shaped mount groove 161 facing the bottom of the main frame body 11 is formed on the center of the upper surface of the foot rest 16, the center of the foot rest 16 is embedded on the main frame body 11 through the mount groove 161, and the inner side wall of the mount groove 161 abuts against the bottom wall of the main frame body 11. The foot rest 16 and the main frame body 11 are tightly fixed by bolts, and the two ends of the foot rest 16 respectively protrude from the bottom of the main frame body 11 and can be placed by the user's feet. By raising the user's footing point, the comfort during riding can be improved, and when driving through a water-storing road section, the water on the road can be prevented from splashing on the user's shoes.

As shown in FIG. 1, the upper end surface of the main frame body 11 is provided with a storage box 17 between the handle 12 and the cushion frame 13. The bottom of the storage box 17 is detachably mounted on the main frame body 11 by bolts. A storage cavity 171 with an upper end opening is formed in the storage box 17, and the opening at the upper end of the storage cavity 171 is provided obliquely downward from the handle 12 toward the direction of the cushion frame 13. A lifting grip 172 is also fixedly mounted on the outer side wall of the storage box 17. The lifting grip 172 is arched and the upper end thereof crosses the upper end of the opening of the storage cavity 171. When the user goes out, the storage box 17 can satisfy the user's storage requirements during riding.

As shown in FIGS. 2 and 3, in order to meet the riding needs of children, the present application also provides a child riding mode, including a child seat 18 provided between the handle 12 and the cushion frame 13. When the user needs to carry a child, the storage box 17 is firstly removed from the main frame body 11, and then the bottom of the child seat 18 is screwed to the main frame body 11 by bolts, so as to meet the children's riding needs. The child seat 18 is mounted above the foot rest 16, and the user can hold the child seated by placing his feet on the foot rest 16 while driving, thereby improving the safety of the child while driving. The end of the child seat 18 facing the handle 12 is fixedly mounted with a armrest 181 for the support of the child. By providing the armrest 181, when children ride, the armrest 181 can be supported by both hands, which can further improve the safety of the children when riding.

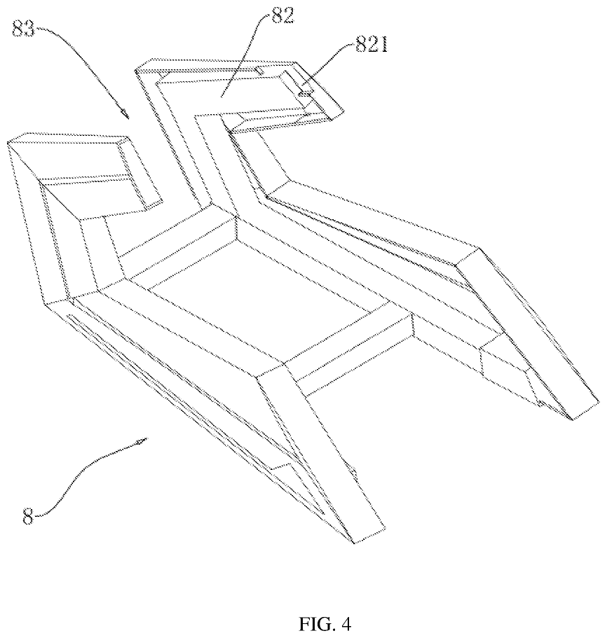

As shown in FIGS. 1 and 4, the intelligent exercise bike also includes a support assembly 8 that includes a base 81 and two connectors 82 integrally formed on the base 81. The connectors 82 are symmetrically provided on the left and right sides of the upper surface of the base 81, and an accommodating cavity 83 into which the rear motor wheel 3 is inserted is enclosed and formed between the two connectors 82 and the upper surface of the base 81. The upper end of the connector 82 is provided with a limit groove 821 facing the accommodating cavity 83, and the two limit grooves 821 are provided oppositely. The outer wall of the main frame body 11 at the rear motor wheel 3 is provided with a plunger facing the limit groove 821, and the main frame body 11 is fixed by being embedded in the respective the opposite limit grooves 821 through the plunger. At this time, the rear motor wheel 3 will be elevated under the action of the support assembly 8, a gap will be formed between the lower end of the rear motor wheel 3 and the upper surface of the base 81, and the rear motor wheel 3 is in a suspended state. Under the action of the support assembly 8, the rear motor wheel 3 can be elevated while maintaining the overall stability of the frame 1. Since there is a gap between the lower end of the rear motor wheel 3 and the base 81, the bike can be switched to an indoor mode at this time. In the indoor mode, the bike is a dynamic cycling bike for fitness, and the user can simply step on the pedal 4 to meet the needs of users for exercise and fitness, at the same time, the main frame body 11 is also provided with a transformer rectifier device located at the pedal motor 5. The input end of the transformer rectifier device is electrically connected to the pedal motor 5. The output end of the transformer rectifier device is connected to the input end of the battery 6. When the bike is switched to the indoor mode, using the principle of magnetizing electricity, the mechanical energy generated by the pedal motor 5 through the rotation of the pedal motor 5 will be converted into electrical energy by the transformer rectifier device, and then the generated current is delivered to the battery 6 by the transformer rectifier device, which can charge the battery 6, and realize the energy cycle.

The implementation principle of the intelligent exercise bike of the embodiment of the present application is that: when the user is riding, the pedal 4 will drive the output shaft of the pedal motor 5 to rotate, and the torque sensor and the Hall provided on the pedal motor 5 can collect the speed and force of the user's pedaling. The torque sensor and the Hall sensor convert the detected physical quantities into transmission signals and send them to the bike controller. After receiving the transmission signals, the bike controller will process the transmission signals, and finally outputs the corresponding control signal to the rear motor wheel 3 to control and adjust the speed and torque of the rear motor wheel 3. The present application removes the chain drive, shaft drive, timing belt drive and other mechanical transmissions in the traditional bike, which can greatly improve the stability during riding and reduce the incidence of mechanical failure of the bike. Moreover, the pedal force is not fed back by the wheels, so it can better adapt to various road conditions and slopes. And the torque force of the pedal motor 5 can also be adjusted by the bike controller, thereby meeting the riding needs of different users. The provision of the speed adjustment knob 7 can achieve the switching of the bike from the bike mode to the electric vehicle mode, thereby meeting the different riding needs of users. When the bike is switched to the electric vehicle mode, it can make driving more labor-saving and convenient. When the bike is switched to the indoor mode, the generated current is delivered to the battery 6 by the transformer rectifier device, which can charge the battery 6, and realize the energy cycle.

The above are the preferred embodiments of the present application, and the protection scope of the present application is not limited accordingly. Therefore, all equivalent changes made according to the structure, shape and principle of the present application should be covered within the scope of protection of the present application.

What is claimed is:

1. An intelligent exercise bike, including a frame (1), and a front wheel (2) and a rear motor wheel (3) that are rotatably provided on the frame (1), characterized in that: a pedal plate (4) and a battery (6) are provided on the frame (1), and the battery (6) is electrically connected to the rear motor wheel (3) and used to supply power to the rear motor wheel (3); the frame (1) is also provided with a pedal motor (5) electrically connected with the pedal plate (4), and an output shaft of the pedal motor (5) is drivingly connected with the pedal plate (4); the pedal motor (5) has a torque sensor and a Hall sensor that are electrically connected thereto for detecting speed and force of the pedal plate (4); a bike controller is provided in the frame (1), and the torque sensor and the Hall sensor convert the detected pedal speed and force into transmission signals, and output them to the bike controller; the bike controller is connected to a power supply circuit of the rear motor wheel (3), and the bike controller outputs a control signal to adjust the output power value of the rear motor wheel (3) after receiving the transmission signals.

2. The intelligent exercise bike according to claim 1, wherein the frame (1) is provided with a speed adjustment knob (7) electrically connected to the bike controller, and by rotating the speed adjustment knob (7), the speed adjustment knob (7) outputs a speed adjustment signal to the bike controller, and after receiving the speed adjustment signal, the bike controller adjusts the power output from the battery (6) to the rear motor wheel (3), such that the speed and torque of the rear motor wheel (3) is controlled.

3. The intelligent exercise bike according to claim 1, wherein the intelligent exercise bike further includes a support assembly (8) that includes a base (81) and connectors (82) provided on the base (81); the connectors (82) are symmetrically provided on both sides of the base (81), and an accommodating cavity (83) for receiving the rear motor wheel (3) is formed between the connectors (82); a limit groove (821) is provided on each connector (82), the frame (1) is fixed by being embedded in the limit groove (821), and a gap exists between a lower end of the rear motor wheel (3) and the base (81).

4. The intelligent exercise bike according to claim 1, wherein the frame (1) includes a main frame body (11), a handle (12) provided at a front end of the main frame body (11), and a cushion frame (13) provided at a rear end of the main frame body (11); a taillight (14) is provided at an end of the cushion frame (13) away from the handle (12) and is electrically connected to the battery (6); a spring shock absorber (15) is provided between the cushion frame (13) and the main frame body (11), one end of the spring shock absorber (15) is connected to the cushion frame (13), and the other end of the spring shock absorber (15) is connected to the main frame body (11).

5. The intelligent exercise bike according to claim 4, wherein the main frame body (11) is provided with a foot rest (16) between the handle (12) and the cushion frame (13), and the foot rest (16) is fixed at the bottom of the main frame body (11); a middle part of the foot rest (16) is provided with a mounting groove (161), through which the foot rest (16) is fixed by being embedded into the main frame body (11); and both ends of the foot rest (16) respectively protrude from the bottom of the main frame body (11).

6. The intelligent exercise bike according to claim 5, wherein a lower end of the handle (12) is hinged to the main frame body (11) through a folding mechanism (9), the folding mechanism (9) is provided with a fastener, and the lower end of the handle (12) is fixed on the main frame body (11) through the fastener.

7. The intelligent exercise bike according to claim 5, wherein the main frame body (11) is provided with a storage box (17) that is provided with a storage cavity (171), and an opening at an upper end of the storage cavity (171) is provided obliquely downward from the handle (12) toward the direction of the cushion frame (13); the storage box (17) is also provided with a lifting grip (172), and an upper end of the lifting grip (172) is erected at the upper end of the opening of the storage cavity (171).

8. The intelligent exercise bike according to claim 7, wherein the main frame body (11) is provided with a child seat (18) between the handle (12) and the cushion frame (13), and the child seat (18) is located above the foot rest (16); and an end of the child seat (18) facing the handle (12) is provided with an armrest (181).
